(19) United States
(12) Patent Application Publication
(10) Pub. No.: US 2020/0210266 A1
(43) Pub. Date: Jul. 2, 2020

(54) UNIVERSAL SERIAL BUS DOCKING APPARATUS AND ERROR DETECTING METHOD THEREOF

(71) Applicant: Acer Incorporated, New Taipei City (TW)

(72) Inventors: Yuan-Yi Li, New Taipei City (TW); Sheng-Yu Weng, New Taipei City (TW)

(73) Assignee: Acer Incorporated, New Taipei City (TW)

(21) Appl. No.: 16/513,665

(22) Filed: Jul. 16, 2019

(30) Foreign Application Priority Data
Jan. 2, 2019 (TW) 108100039

(51) Int. Cl. G06F 11/07; G06F 11/14; G06F 13/40; G06F 13/42; G06F 1/26; G06F 1/16

(52) U.S. Cl. CPC G06F 11/0757; G06F 11/1441; G06F 11/0706; G06F 11/0793; G06F 2201/805; G06F 13/4282; G06F 1/26; G06F 1/1632; G06F 2213/0042; G06F 13/4068

(57) ABSTRACT

A universal serial bus (USB) docking apparatus and an error detecting method thereof are provided. The USB docking apparatus includes a connection port and a charging controller. The connection port is configured to connect an external electrical device electrically. The charging controller is electrically connected to the connection port to receive a pin-configuration signal and decides to execute a first power transition mode or a second power transition mode based on the pin-configuration signal. The charging controller decides to execute the first power transition mode and counts a first suspending time, wherein when the first suspending tine is larger than or equal to a threshold time value, the charging controller switches the first power transition mode to the second power transition mode.

### CROSS-REFERENCE TO RELATED APPLICATION

This application claims the priority benefit of Taiwan application serial no. 108100039, filed on Jan. 2, 2019. The entirety of the above-mentioned patent application is hereby incorporated by reference herein and made a part of this specification.

### BACKGROUND

### Technical Field

The present invention relates to an interface transition technology. More particularly, the present invention relates to a universal serial bus docking apparatus and an error detecting method thereof.

### Description of Related Art

The portable electronic devices have become an integral part of modern life. These electronic devices can be connected to each other via the communication interface for expansion. One current common communication interface is universal serial bus (USB). In the current USB protocol, USB Type-C, also known as USB-C, can support a plurality of dual role port (DRP) and ultra-high speed data transition, and it is served as an input/output port of the power with the wide range. As a result, USB is the general communication interface currently.

When both electronic devices are connected to each other to supply power from one to the other via the USB Type-C interface, it is needed to decide one of them as the host device (Host) for supplying the power and the other as the slave device (Slave) for receiving the power. However, sometimes the power source roles between the electronic devices can be exchanged so that the problem of pairing failure may occur, causing the communication failure.

FIG. 3 is a pairing flow chart of a universal serial bus docking apparatus according to the prior art. Please refer to FIG. 3, in step S310, the current USB docking apparatus electrically connected to an external electrical device to select to execute a sink mode or a source mode. In step S320, the USB docking apparatus executes the sink mode. In step S330, The USB docking apparatus executes the source mode. However, if the external electrical device is in the state of power saving and not able to supply power, it may cause problems when the USB docking apparatus selects to execute the sink mode so that step S340 is not processed from step S320, resulting in pairing failures. Therefore, how to avoid misjudgment of the power source roles between the electronic devices becomes an important issue.

### SUMMARY

The present invention provides a universal serial bus docking apparatus and an error detecting method thereof, which can prevent two electronic devices from failing in power transition communication pairing.

An embodiment of the present invention provides a universal serial bus docking apparatus which includes a connection port and a charging controller. The connection port is configured to be electrically connected to an external electrical device. The charging controller is electrically connected to the connection port to receive a pin-configuration signal and select to execute a first power transition mode or a second power transition mode according to the pin-configuration signal, wherein the charging controller executes the first power transition mode and counts a first suspending time, wherein the charging controller is switched to the second power transition mode from the first power transition mode when the first suspending time is greater than or equal to a time threshold value.

In an invention of the present invention, the first power transition mode in the universal serial bus docking apparatus as mentioned above is a sink mode, and the second power transition mode is a source mode.

In an invention of the present invention, in the universal serial bus docking apparatus as mentioned above, after the charging controller is switched to the second power transition mode from the first power transition mode, the external electrical device also executes the first power transition mode correspondingly, so that the universal serial bus docking apparatus charges the external electrical device.

In an invention of the present invention, the universal serial bus docking apparatus as above mentioned charges the external electrical device according to a power delivery protocol.

In an invention of the present invention, in the universal serial bus docking apparatus as mentioned above, the charging controller executes the second power transition mode and counts a second suspending time, wherein the time threshold value is set to be greater than the second suspending time.

In an invention of the present invention, in the universal serial bus docking apparatus as above mentioned, the charging controller executes an error recovery mode to re-enter the second power transition mode when the first suspending time is greater than or equal to the time threshold value.

An embodiment of the present invention provides an error detecting method of a universal serial bus docking apparatus. The error detecting method of the universal serial bus docking apparatus includes the following steps: electrically connecting to an external electrical device via a connection port, and receiving a pin-configuration signal from the connection port to select to execute a first power transition mode or a second power transition mode, wherein counting a first suspending time when executing the first power transition mode, wherein switching to the second power transition mode from the first power transition mode when the first suspending time is greater than or equal to a time threshold value.

In an invention of the present invention, in the error detecting method as mentioned above, wherein the first power transition mode is a sink mode, and the second power transition mode is a source mode.

In an invention of the present invention, in the error detecting method as mentioned above, wherein switching to the second power transition mode from the first power transition mode includes: selecting to execute the second power transition mode by the external electrical device when selecting to execute the first power transition mode, and executing also the first power transition mode correspondingly by the external electrical device so that the universal serial bus docking apparatus charges the external electrical device after the universal serial bus docking apparatus switched to the second power transition mode from the first power transition mode.

In an invention of the present invention, in the error detecting method as mentioned above, wherein the universal serial bus docking apparatus charges the external electrical device according to a power delivery protocol.

In an invention of the present invention, in the error detecting method as mentioned above, wherein selecting to execute the second power transition mode includes: counting a second suspending time, wherein the time threshold value is set to be greater than the second suspending time.

In an invention of the present invention, in the error detecting method as mentioned above, wherein switching to the second power transition mode from the first power transition mode includes: executing an error recovery mode to re-enter the second power transition mode.

Based on the above, the universal serial bus docking apparatus and the error detecting method thereof provided by the present invention may ensure that the power source roles can be automatically modified during the interface communication to complete the power transition between two electronic devices with DRP function, even when the power source roles are assigned inappropriately.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a universal serial bus docking apparatus according to an embodiment of the invention.

FIG. 2 is a flow chart illustrating an error detecting method of the universal serial bus docking apparatus according to an embodiment of the invention.

FIG. 3 is a pairing flow chart illustrating a universal serial bus docking apparatus according to the prior art.

### DESCRIPTION OF THE EMBODIMENTS

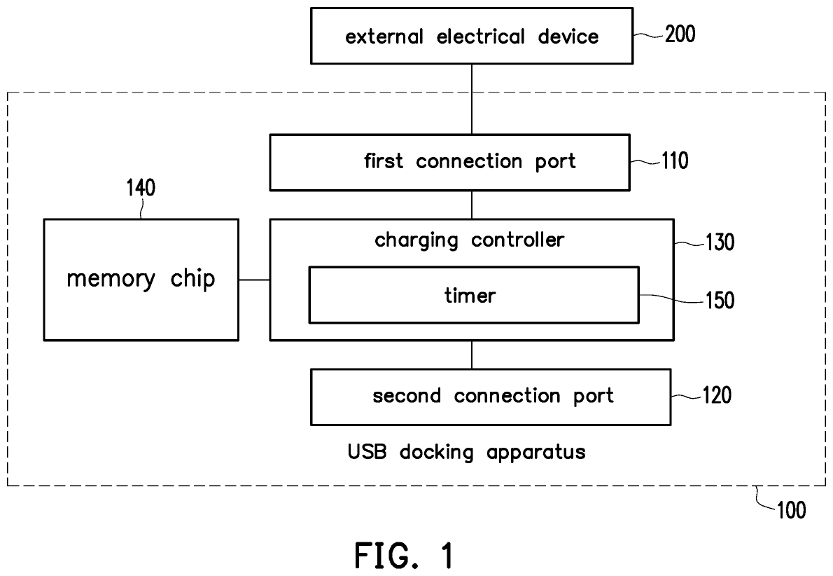

FIG. 1 is a schematic diagram illustrating a universal serial bus docking apparatus according to an embodiment of the invention. The universal serial bus (USB) docking apparatus 100 includes at least one connection port to connect an electrical device, such as a downstream facing port (DFP) or an upstream facing port (UFP). Please refer to FIG. 1, the USB docking apparatus 100 includes a first connection port 110, a second connection port 120, and a charging controller 130. The first connection port 110 is configured to be electrically connected to an external electrical device 200, and the USB docking apparatus 100 can be electrically connected to the other electrical devices or the USB peripheral devices via the second connection port 120. In this embodiment, the first connection port 110 can support USB Type-C protocol and a dual role port (DRP), and the connection port of the external electrical device 200 can also support the DRP.

A charging controller 130 is electrically connected to the first connection port 110 and the second connection port 120. The charging controller 130 receives a pin-configuration signal from the first connection port 110 and selects to execute a first power transition mode or a second power transition mode according to the pin-configuration signal. Herein, the first power transition mode refers to a sink mode, and the second power transition mode refers to the source mode. The charging controller 130 may count a first suspending time when executing the first power transition mode, wherein when the first suspending time is greater than or equal to a time threshold value, it indicates that external electrical device 200 may not be suitable for the power source role at present, and the charging controller 130 will switch to the second power transition mode from the first power transition mode.

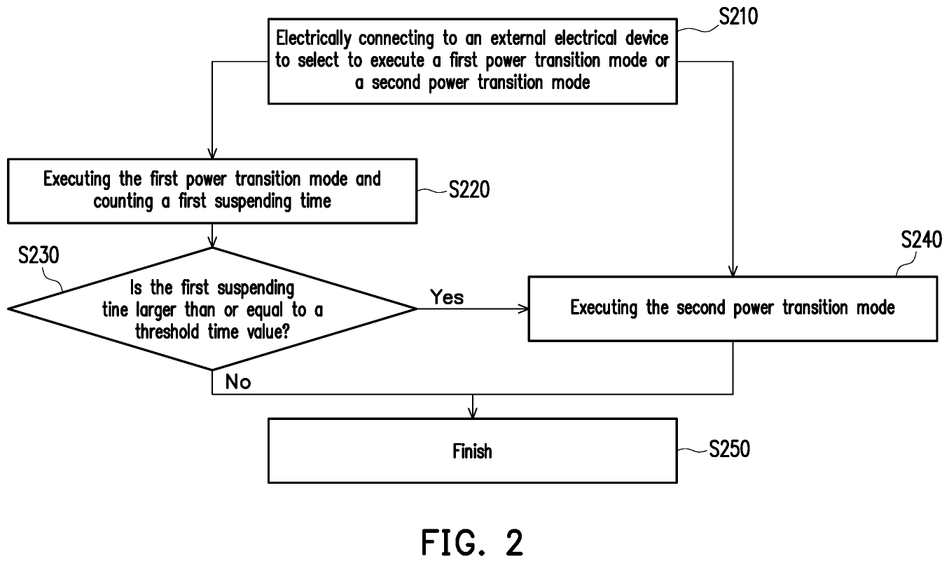

FIG. 2 is a flow chart illustrating an error detecting method of the universal serial bus docking apparatus according to an embodiment of the invention. The error detecting method illustrated in FIG. 2 is suitable for the USB docking apparatus 100 illustrated in FIG. 1. The implementation details of the USB docking apparatus 100 and the error detecting method are further explained below with reference to the elements of FIG. 1.

In particular, the external electrical device 200 or the electrical device connected to the USB docking apparatus 100 may be a personal computer, a laptop, a tablet computer, a mobile phone, a personal digital assistant (PDA), a media player, a digital camera, a camcorder, a game consoles, etc., and the present invention is not limited thereto.

A charging controller 130 may include a controller, a microcontroller, a microprocessor, an application-specific integrated circuit (ASIC), a digital signal processor (DSP), a field programmable gate array (FPGA), or other processing/control circuits. The USB docking apparatus 100 also includes a memory chip 140 coupled to the charging controller 130. The memory chip 140 stores the firmware code of the power transition. The charging controller 130 may execute the firmware code of the power transition provided by the memory chip 140 and then provide the control function of the power transition. For example, the USB docking apparatus 100 may charge the external electrical device 200 according to the power delivery (PD) protocol and also support multiple fast charging modes, and the present invention is not limited thereto.

Please refer to FIG. 2, in step S210, the USB docking apparatus 100 is electrically connected to the external electrical device 200 to select to execute the first power transition mode or the second power transition mode. The USB docking apparatus 100 is electrically connected to the external electrical device 200 via the first connection port 110. The charging controller 130 may determine the state of the configuration channel pin (CC pin) based on the pin-configuration signal received from the first connection port 110. For example, it is judged whether the first connection port 110 connects to an external device (e.g., the external electrical device 200 shown in FIG. 1). The USB docking apparatus 100 may also be configured to exchange configuration information with external electrical device 200 via the configuration channel pin. According to the configuration information, the USB docking apparatus 100 and the external electrical device 200 may automatically communicate and determine the power source roles of both parties.

If the USB docking apparatus 100 is served as a sink terminal of the power transition, and the external electrical device 200 is served as a source terminal of the power transition, then the flow enters step S220 so that the USB docking apparatus 100 executes the first power transition mode and count the first suspending time. The charging controller 130 will determine or further detect the pin state of the first connection port 110 during the process of executing the first power transition mode. The pins of the first connection port 110 may include the differential signal to input/output pin (TX/RX), bus power pin (VBUS), ground pin (GND), the configuration channel pair pins (CC1 and CC2 pin) and so on. The charging controller 130 will confirm that the first connection port 110 is changed to the status of attached sink terminal (Attached.SNK) from the status of unattached sink terminal (Unattached.SNK) to indicate that the pairing with each other is successful and then enter step S250.

The charging controller 130 further includes a timer 150. In the process as mentioned above, the timer 150 may count time which is called a first suspending time. In step S230, the charging controller 130 will continue to compare the first suspending time and the time threshold value. If the first suspending time is equal to or greater than the time threshold value, and the USB docking apparatus 100 and the external electrical device 200 still have not completed the communication pairing, the flow enters step S240 and the charging controller 130 switches to the second power transition mode.

For instance, the time threshold value is set to 3 seconds, which is not limited by the invention, the charging controller 130 selects to execute the first power transition mode, and the external electrical device 200 selects to execute the second power transition mode, that is, the external electrical device 200 is served as the source terminal, and the USB docking apparatus 100 is served as the sink terminal. When the charging controller 130 has taken more than three seconds but still not completed the communication pairing, the charging controller 130 will switch to the second power transition mode from the first power transition mode. After the charging controller 130 switches to the second power transition mode from the first power transition mode, the external electrical device 200 also switches to the first power transition mode accordingly. The external electrical device 200 is changed to serve as the sink terminal, and the USB docking apparatus 100 is changed to serve as the source terminal. So that the USB docking apparatus 100 charges the external electrical device 200.

In addition, in this embodiment, when the first suspending time is greater than or equal to the time threshold value, the charging controller 130 executes an error recovery (ErrorRecovery) mode to re-enter the second power transition mode. When the connection confirmation of the sink terminal is not successfully completed, the error recovery mode of the USB docking apparatus 100 has the function of switching to the second power transition mode, and the pin can be reassigned. Therefore, this function is different from the prior art.

In step S240, the USB docking apparatus 100 executes the second power transition mode. The USB docking apparatus 100 is served as the source terminal in the power transition and the external electrical device 200 is served as the sink terminal. After confirming that the first connection port 110 has been changed to the status of attached sink terminal (Attached.SNK) from the status of unattached sink terminal (Unattached.SNK), the process proceeds to step S250, and the pairing is completed.

The charging controller 130 can count a second suspending time when executing the second power transition mode, and the time threshold value will be set to be greater than the second suspending time.

In the process of confirming the status of attached source terminal (Attached.SRC) of the first connection port 110, the timer 150 can also count time to generate the second suspending time (this action is not required in some embodiment). The second suspending time has a corresponding time reference value indicating the indicative spending time taken from step S240 to step S250. For example, the time reference value is an average spending time, the time reference value is that the second suspending time will not exceed in the normal operation, and so on. The time reference value may be less than the time threshold value in step S230. For example, the time threshold value is set to 3 seconds, the second suspending time spends 1 second, and the time reference value is 1.2 seconds.

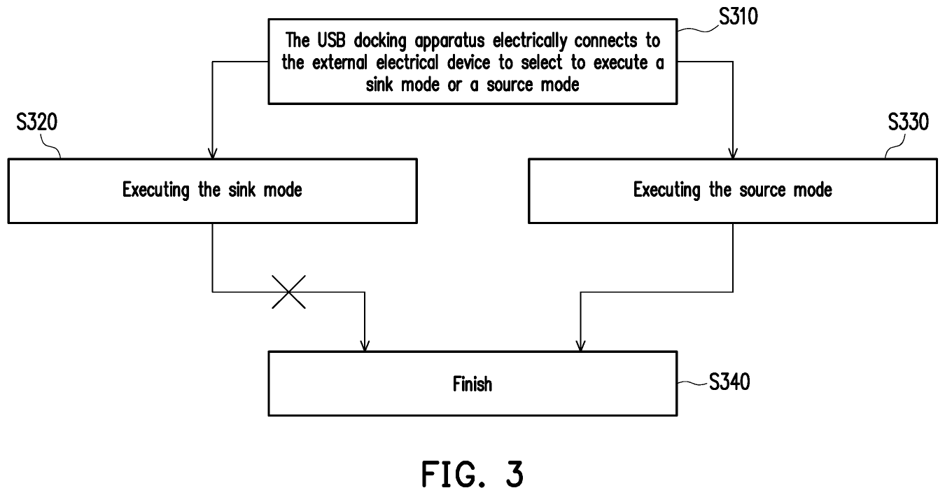

Table 1 and Table 2 provided below show the result that the power transition communication failure rate between the electronic devices of the present invention is improved. Table 1 shows that 50% of the transition communication failure rate will occur if the external electrical device is set to a power saving mode and cannot supply power when the general USB docking apparatus (please refer to FIG. 3) connects to the external electrical device. Table 2 shows that the transition communication failure rate will be minimized when the USB docking apparatus 100 in the present invention connects to the external electrical device 200. When the USB docking apparatus 100 selects to serve as the sink terminal, the USB docking apparatus 100 will automatically switch the mode to successfully complete the pairing, even if the external electrical device 200 cannot be served as the source terminal.

TABLE 1

| | General USB docking apparatus | | | |
|---|---|---|---|---|
| | power source | | | |
| Failure rate | role | DRP | DRP/Try. SRC | DRP/Try. SNK |
| external | DRP | 50% | 50% | 100% |
| electrical | DRP/Try. SRC | 100% | 100% | 100% |
| device | DRP/Try. SNK | 0% | 0% | 0% |

TABLE 2

| | USB docking apparatus of the present invention | | | |
|---|---|---|---|---|
| | power source | | | |
| Failure rate | role | DRP | DRP/Try. SRC | DRP/Try. SNK |
| external | DRP | 0% | 0% | 0% |
| electrical | DRP/Try. SRC | 0% | 0% | 0% |
| device | DRP/Try. SNK | 0% | 0% | 0% |

In summary, in the universal serial bus docking apparatus and the error detecting method thereof in the present invention, the USB docking apparatus may count time to generate the first suspending time when the power configuration between the USB docking apparatus and the external electrical device is the first power transition mode. If the first suspending time is greater than or equal to the time threshold value, the USB docking apparatus will automatically switch to the second power transition mode to complete the power transition configuration for both devices. In this way, the power source role pairing failure between the electronic devices can be avoided.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A universal serial bus docking apparatus, comprising:
a connection port, configured to be electrically connected to an external electrical device; and
a charging controller, electrically connected to the connection port to receive a pin-configuration signal and select to execute a first power transition mode or a second power transition mode according to the pin-configuration signal,
wherein the charging controller executes the first power transition mode and counts a first suspending time, wherein the charging controller is switched to the second power transition mode from the first power transition mode when the first suspending time is greater than or equal to a time threshold value.

2. The universal serial bus docking apparatus according to claim 1, wherein the first power transition mode is a sink mode and the second power transition mode is a source mode.

3. The universal serial bus docking apparatus according to claim 2, wherein after the charging controller is switched to the second power transition mode from the first power transition mode, the external electrical device also executes the first power transition mode correspondingly so that the universal serial bus docking apparatus charges the external electrical device.

4. The universal serial bus docking apparatus according to claim 3, wherein the universal serial bus docking apparatus charges the external electrical device according to a power delivery protocol.

5. The universal serial bus docking apparatus according to claim 1, wherein the charging controller executes the second power transition mode and counts a second suspending time, wherein the time threshold value is set to be greater than the second suspending time.

6. The universal serial bus docking apparatus according to claim 1, wherein the charging controller executes an error recovery mode to re-enter the second power transition mode when the first suspending time is greater than or equal to the time threshold value.

7. An error detecting method of a universal serial bus docking apparatus, comprising:
electrically connecting to an external electrical device via a connection port; and
receiving a pin-configuration signal from the connection port to select to execute a first power transition mode or a second power transition mode,
wherein counting a first suspending time when executing the first power transition mode, wherein switching to the second power transition mode from the first power transition mode when the first suspending time is greater than or equal to a time threshold value.

8. The error detecting method of the universal serial bus docking apparatus according to claim 7, wherein the first power transition mode is a sink mode, and the second power transition mode is a source mode.

9. The error detecting method of the universal serial bus docking apparatus according to claim 8, wherein switching to the second power transition mode from the first power transition mode comprising:
selecting to execute the second power transition mode by the external electrical device when selecting to execute the first power transition mode; and
executing the first power transition mode correspondingly by the external electrical device so that the universal serial bus docking apparatus charges the external electrical device after the universal serial bus docking apparatus switched to the second power transition mode from the first power transition mode.

10. The error detecting method of the universal serial bus docking apparatus according to claim 9, wherein the universal serial bus docking apparatus charges the external electrical device according to a power delivery protocol.

11. The error detecting method of the universal serial bus docking apparatus according to claim 7, wherein selecting to execute the second power transition mode comprising:
counting a second suspending time, wherein the time threshold value is set to be greater than the second suspending time.

12. The error detecting method of the universal serial bus docking apparatus according to claim 7, wherein switching to the second power transition mode from the first power transition mode comprising:
executing an error recovery mode to re-enter the second power transition mode.
